(19) United States
(12) Patent Application Publication
(10) Pub. No.: US 2022/0169142 A1
(43) Pub. Date: Jun. 2, 2022

(54) Method for Operating a Charging Station for an Electrically Driven Motor Vehicle

(71) Applicant: Daimler AG, Stuttgart (DE)

(72) Inventors: Matthias KRONEWITTER, Esslingen (DE); Christoph SCHWILL, Euskirchen (DE)

(21) Appl. No.: 17/437,647

(22) PCT Filed: Mar. 2, 2020
(86) PCT No.: PCT/EP2020/055394

§ 371 Date: Sep. 9, 2021

(30) Foreign Application Priority Data
Mar. 11, 2019 (DE) 10 2019 001 700.5

(51) Int. Cl. B60L 53/68; A47G 29/14; B60L 53/124; A47G 29/20

(52) U.S. Cl. CPC B60L 53/68; A47G 29/141; B60L 2250/10; A47G 29/20; B60L 53/124

(57) ABSTRACT

A method for operating a charging station for an electrically driven motor vehicle. The charging station has a parcel depot at which a product can be deposited for delivery or collection. The method includes controlling the parcel depot by a control device of the charging station via an already present communication link of the charging station with a network.

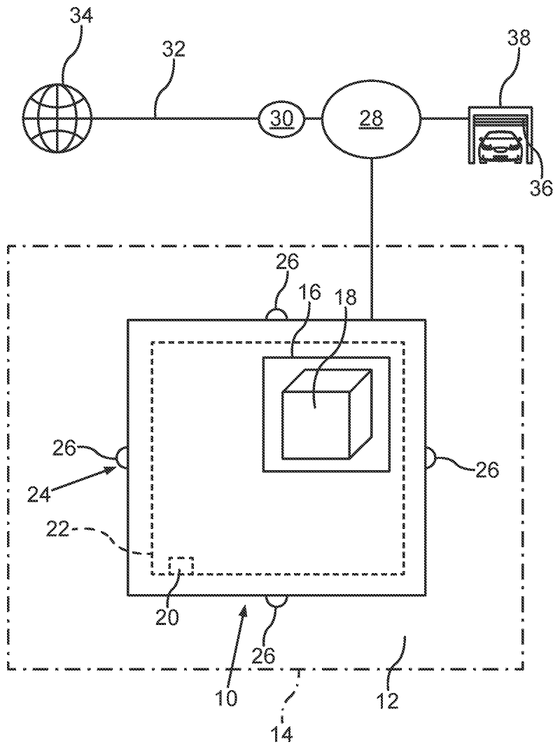

### BACKGROUND AND SUMMARY OF THE INVENTION

The invention relates to a method for operating a charging station for an electrically driven motor. Furthermore, the invention relates to such a charging station.

From US 2018/0186454 A1, an autonomously operable delivery vehicle is already known, by means of which parcels can be delivered to a respective parcel depot or collected therefrom. The parcel depot also comprises, among other things, a charging station, by means of which a storage device for supplying the power unit of the electrically driven motor vehicle with electric current can be charged.

The object of the present invention is to create a method for operating a charging station for an electrically driven motor vehicle as well as a charging station itself, by means of which a system for the delivery and collection of goods can be created in a particularly favorable manner.

The method according to the invention is characterized by the fact that goods are deposited at a parcel depot of the charging station for delivery or collection. Here, use is made of the basic idea that such charging stations will be used in the future to a greater extent, in particular in private houses, which are used either by one or several parties. In order to be able to deposit the goods for delivery or collection in the area of the charging station in a particularly favorable manner, it is provided according to the invention that the parcel depot is regulated by means of a control device of the charging station via a communication link of the charging station with a network. Here, one uses a communication link of the charging station, which is usually provided by a corresponding transmitting and receiving unit of the charging station, and which is connected to the control device of the charging station, in order, for example, to arrange corresponding appointments with a delivery or collection service of the goods or to monitor corresponding deliveries or collections of the goods. Here, it is particularly advantageous if an already existing communication link of the charging station, which is usually an Internet connection, can be used to control the parcel depot. Thus, synergies can be used and the charging station can be transferred to an additional function, namely the deposition of respective goods for delivery or collection.

In this context, it has been shown to be particularly advantageous if the parcel depot is controlled depending on sensor data from at least one sensor device of the charging station connected to the control device. With such a sensor device, by means of which, for example, the presence of a product in the parcel depot can be detected, a corresponding control can thus be provided in a simple manner.

In this context, it has been shown to be particularly advantageous if the parcel depot is controlled depending on sensor data from a sensor device connected to the control device for detecting metallic objects and/or a motion sensor device for detecting a living being of an inductive charging station. Here, one makes use of the basic idea that an inductive charging station usually has a sensor device for detecting metallic objects in order to avoid their overheating in the vicinity of a primary coil of the charging station. Likewise, one makes use of the basic idea that an inductive charging station usually also has a motion sensor device for detecting a living being such that, for example, the primary coil can be switched off in good time if, for example, an animal approaches the primary coil excessively.

In a further design of the invention, the charging station can be used to monitor goods in such a way that an alarm is triggered in the event of unauthorized removal of the goods from the parcel depot. This can be transmitted in a simple manner via the already existing communication link, for example to the user of the parcel depot.

Furthermore, it has been shown to be advantageous if, by means of the control device, at least one access to a space in which the parcel depot or the charging station is located is controlled or regulated. In other words, for example, a garage or underground car park can be used as a secure space surrounding the parcel depot, wherein at least one access point, for example a gate or a door, is opened by means of the control device when, for example, a delivery or collection service requires access to the underground car park or garage.

Alternatively, of course, the parcel depot can also have a compartment or similar which can be locked or opened in a similar manner.

The advantages described above in connection with the method according to the invention apply in the same way to the charging station according to the invention.

Further advantages, features and details of the invention emerge from the following description of preferred exemplary embodiments and from the drawing. The features and combinations of features mentioned above in the description, as well as the features and combinations of features mentioned below in the description of the figure and/or shown in the single figure alone, can be used not only in the combination indicated in each case, but also in other combinations or on their own, without departing from the scope of the invention.

### BRIEF DESCRIPTION OF THE DRAWING

The FIGURE shows, in a schematic representation, an inductive charging station for an electrically driven motor vehicle having a parcel depot at which goods are deposited for delivery or collection, wherein the parcel depot is regulated by means of a control device via a communication link of the charging station with a network in the form of an Internet connection.

### DETAILED DESCRIPTION OF THE DRAWING

In the present case, a charging station 10 for an electrically driven motor vehicle, which is schematically indicated in the single FIGURE, is embedded in a floor 12 of a parking space 14. As will be explained in more detail below, this parking space 14 can be located in an area freely accessibly to the public or, in particular, in a garage or underground car park accessible only to a limited group of people.

The extremely schematically depicted charging station 10 here comprises a parcel depot 16, at which parcels or similar goods 18 can be deposited for delivery or collection, for example by a delivery or collection service.

In addition to this parcel depot 16, the charging station 10 comprises a sensor device 20, by means of which metallic objects can be detected in the region of a dashed sensor surface 22. Such a sensor device 20 is usually provided in charging stations for inductively charging a storage device of an electrically driven motor vehicle, in order to protect metallic objects in the vicinity of a primary coil of the charging station 10, which is not shown further, from heating. In the present case, the sensor device 20 is not only provided for sensing respective metallic objects, but also for checking the presence of a product 18 on the parcel depot 16. For this purpose, a simply defined metallic object or, for example, also an RFID chip need only be provided on or in the product 18. In other words, the sensor device 20 for detecting metallic objects before overheating, which is present anyway, can accordingly also be used to identify corresponding goods 18.

Furthermore, the charging station comprises a motion sensor device 24 having respective motion sensors 26, by means of which a living being, in particular an animal, can be detected which approaches the inductive charging station unduly. Such motion sensors 26 or a motion sensor device 24 created in such a way is usually provided to protect living beings from the magnetic field during charging by means of the charging station 10. In the present case, the motion sensor device 24 can also be used in its actual function to detect, for example, a movement of a person during delivery or collection of a product 18 in a manner to be described in further detail below.

The present charging station 10 comprises a control device 28, by means of which, for example, on the one hand the functions for charging an electrical storage device of an electrically driven motor vehicle are controlled and by means of which, on the other hand, the method for operating a charging station according to the invention is accomplished. The control device 28 is thereby connected to a transmitting and receiving unit 30, via which a communication link 32 of the charging station 10 or of the control device 28 with a network can be established. In the present case, the communication link 32 is a connection of the control device 28 to the Internet 34, but other networks, for example a network provided by a service provider, would also be conceivable. The communication link 32 with the Internet 34 is required in charging stations 10, for example, in order to select the associated provisioning services for the electrical power for respective consumers or to carry out corresponding billing on the basis of the power consumption. Such communication links 32 are also required for other services, with which on the one hand the respective motor vehicle to be charged and on the other hand the associated service data are to be determined or matched.

The core of the present method is now that this communication link 32 is also used to regulate the parcel depot 16. By way of example, the delivery or collection of goods 18 can be organized and monitored via this Internet connection 32. By way of example, a delivery or collection service on the one hand and the sender or recipient of the goods on the other hand can be sent respective messages as part of this method. By means of the sensor devices 20 and 24, as already described, the respective goods 18 located on the parcel depot 16 can be identified and a delivery or collection of the corresponding goods 18 can be detected by means of the motion sensor device 24. In this context, an unauthorized removal or similar movement of the goods 18 can also be detected. In the event of unauthorized removal, an acoustic alarm can thus be triggered, for example, and an alarm can be sent via the Internet. Accordingly, a visual warning of the removal of the corresponding parcel 18 can be given on site.

The control device 28 can also be connected to an access point 36, for example a garage door, a door or similar, to a space 38, for example a garage, underground car park or similar, in which the parcel depot 16 or the charging station 10 is located. Thus, the charging station 10 can be used, for example, in a garage 38 to allow the parcel deliverer or collector to open the garage 38 via the Internet access of the charging station 10 and, after depositing the parcel in the garage, to allow it to be closed again after the motion sensor device 24 of the charging station 10 no longer detects any movement. The deliverer or collector of the goods 18 can thus be given access to the parcel depot 16 by opening the access point 36.

In this context, it is also conceivable that, as an alternative to the inductive charging station 10, a conductive charging station is also used to accomplish the described method, since such charging stations also have Internet access and can, for example, control the opening and closing of the access point 36 via a corresponding switching output.

1.-8. (canceled)

9. A method for operating a charging station (10) for an electrically driven motor vehicle, wherein the charging station (10) has a parcel depot (16) at which a product (18) can be deposited for delivery or collection, comprising the step of:
controlling the parcel depot (16) by a control device (28) of the charging station (10) via an already present communication link (32) of the charging station (10) with a network.

10. The method according to claim 9, wherein the parcel depot (16) is controlled depending on sensor data of a sensor device (20) of the charging station (10).

11. The method according to claim 9, wherein the charging station (10) is an inductive charging station (10) and wherein the parcel depot (16) is controlled depending on sensor data of a sensor device (20) for detecting metallic objects and/or of a motion sensor device (24) for detecting a living being.

12. The method according to claim 9, further comprising the step of triggering an alarm in an event of an unauthorized removal of a deposited product (18) from the parcel depot (16).

13. The method according to claim 9, further comprising the step of controlling or regulating an access point (36) to a space (38) in which the parcel depot (16) or the charging station (10) is located by the control device (28).

14. A charging station (10) for an electrically driven motor vehicle, comprising:
a parcel depot (16) at which a product (18) can be deposited for delivery or collection;
a communication link (32); and
a control device (28), wherein the parcel depot (16) is controllable by the control device (28) via the communication link (32) with a network.

15. The charging station (10) according to claim 14, further comprising:
a sensor device (20), wherein the parcel depot (16) is controllable depending on sensor data of the sensor device (20).

16. The charging station (10) according to claim 14, wherein the charging station (10) is an inductive charging station (10) and wherein the parcel depot (16) is controllable depending on sensor data of a sensor device (20) for detecting metallic objects and/or of a motion sensor device (24) for detecting a living being.
